(19) United States
(12) Patent Application Publication
(10) Pub. No.: US 2006/0168360 A1
(43) Pub. Date: Jul. 27, 2006

(54) Disk playback apparatus and disk playback method

(75) Inventors: Tatsuji Ashitani, Yokohama-shi (JP); Atsushi Takeda, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/338,699

(22) Filed: Jan. 25, 2006

(30) Foreign Application Priority Data
Jan. 26, 2005 (JP) 2005-018427

(51) Int. Cl. G06F 3/00

(52) U.S. Cl. 710/8

(57) ABSTRACT

A disk apparatus has reader unit which reads disk having re-writable storage area, a plurality of defect management areas, and a plurality of location information areas that indicate the location of optimum one to be played back in the plurality of defect management areas, and which outputs readout signal, playback unit which plays back information stored in the rewritable storage area in response to the readout signal of the reader unit on the basis of given defect management information, and controller unit which, when all the plurality of location information stored in the location information areas are accessed and some of them but not all are read out successfully, selects the latest location information among the plurality of location information read out successfully and controls the playback unit to execute playback operation on the basis of one item of the defect management information specified by the selected latest location information.

### CROSS-REFERENCE TO RELATED APPLICATIONS

This application is based upon and claims the benefit of priority from prior Japanese Patent Application No. 2005-018427, filed Jan. 26, 2005, the entire contents of which are incorporated herein by reference.

### BACKGROUND

1. Field

The present invention relates to a disk playback apparatus and a disk playback method for playing back an information recording medium which includes a defect management area in which defect management information is stored, and particularly to a disk playback apparatus and a disk playback method provided for use with a defect compensating technique of specifying one set of a plurality of defect management information by using a plurality of location information in the disk.

2. Description of the Related Art

Information storage media such as an optical disk has a user area for storing user information and thus includes a mechanism for compensating any defect that occurs in the user area. The mechanism is known as a replacement process. An area where information relating to the replacement process, that is, defect management information is managed is called defect management area (DMA).

A DVD-RAM, one of the known information storage media, is capable of over-writing 100,000 times or more. Even if the over-writing operation is repeated tens of thousands of times on DMAs of a medium having a remarkable high durability against such over-writing, the DMAs have to remain intact in the reliability. For the purpose, a plurality of DMAs are provided for being updated one after another because of being wasted. There are also provided a plurality of DMA managers for specifying the latest of the DMAs. The DMA managers are also updated one after another when having been worn down.

Such DMAs and DMA managers as described above are disclosed in Patent Document 1 (Jpn. Pat. Appln. KOKAI Publication No. 2004-288285). The publication discloses the technique in which the latest of the DMA managers specifies the location of the latest DMA, whereby the DMA as defect management information of a current disk is used to stably execute a playback operation while avoiding a defect area on the disk.

However, the technique disclosed in Patent Document 1 may fail to retrieve the latest among a plurality of DMA managers due to injury or dirt on the disk. It is hence essential to determine how to specify the latest of the DMA managers and thus the latest DMA when some or all of the DMA managers have been inhibited from being retrieved.

### BRIEF SUMMARY OF THE INVENTION

An embodiment of the present invention is a disk apparatus comprising: a reader unit which reads a disk having a re-writable storage area, a plurality of defect management areas, and a plurality of location information areas that indicate the location of optimum set of DMAs to be played back in the plurality of defect management areas, and which outputs a readout signal; a playback unit which plays back information stored in the rewritable storage area in response to the readout signal of the reader unit on the basis of given defect management information; and a controller unit which, when all the plurality of location information stored in the location information areas are accessed and some of them but not all are read out successfully, selects the latest location information among the plurality of location information read out successfully and controls the playback unit to execute a playback operation on the basis of one item of the defect management information specified by the selected latest location information.

Another embodiment of the present invention is a disk reproducing method comprising: reading a disk having a re-writable storage area, a plurality of defect management areas, and a plurality of location information areas that indicate the location of optimum set of DMAs to be reproduced in the defect management areas, and outputting a readout signal; reading the plurality of location information stored in the location information areas in response to the readout signal, and when reading some but not all of the plurality of location information, selecting the latest location information among the plurality of location information which have been read out successfully, and determining one set of the defect management information specified by the latest location information; and playing back information of the readout signal stored in the re-writable storage area on the basis of the determined one set of the defect management information.

### BRIEF DESCRIPTION OF THE SEVERAL VIEWS OF THE DRAWINGS

FIG. 1 is a diagram showing an example of a schematic configuration of an information record/playback apparatus according to one embodiment of the present invention;

FIG. 2 is an external view of a recording medium to be handled by the information record/playback apparatus of one embodiment of the invention;

FIG. 3 is an explanatory view showing an allocation of DMAs on a DVD-RAM to be handled by the information record/playback apparatus of one embodiment of the invention;

FIG. 4 is an explanatory view showing another allocation of DMAs on a DVD-RAM to be handled by the information record/playback apparatus of one embodiment of the invention;

FIG. 5 is a flowchart showing one example of a DMA manager processing operation executed by the information record/playback apparatus of one embodiment of the invention;

FIG. 6 is a flowchart showing one example of the DMA manager processing operation executed by the information record/playback apparatus of one embodiment of the invention;

FIG. 7 is a flowchart showing another example of the DMA manager processing operation executed by the information record/playback apparatus of one embodiment of the invention;

FIG. 8 is a flowchart showing another example of the DMA manager processing operation executed by the information record/playback apparatus of one embodiment of the invention;

FIG. 9 is an explanatory view showing one example of a sequence of the playback operation executed by the information record/playback apparatus of one embodiment of the invention;

FIG. 10 is an explanatory view showing one example of the sequence of the playback operation executed by the information record/playback apparatus of one embodiment of the invention;

FIG. 11 is an explanatory view showing one example of the sequence of the playback operation executed by the information record/playback apparatus of one embodiment of the invention;

FIG. 12 is an explanatory view showing one example of the sequence of the playback operation executed by the information record/playback apparatus of one embodiment of the invention;

FIG. 13 is an explanatory view showing one example of the sequence of the playback operation executed by the information record/playback apparatus of one embodiment of the invention;

FIG. 14 is an explanatory view showing an allocation of address areas for the replacing operation executed by the information record/playback apparatus of one embodiment of the invention;

FIG. 15 is a flowchart showing one example of the replacing operation executed by the information record/playback apparatus of one embodiment of the invention;

FIG. 16 illustrates an example of contents to be written in the leading sector of a DDS/PDL block in DMA of a disk to be handled by the information record/playback apparatus of one embodiment of the invention;

FIG. 17 illustrates an example of contents to be written in the SDL block in the DMA;

FIG. 18 illustrates an allocation of the DMAs and manager storage areas and an example of a data structure of the manager storage area on the medium;

FIG. 19 illustrates an example of a data structure of a DMA manager to be stored in one manager reserved area in the manger storage area;

FIG. 20 illustrates an allocation of the DMA managers and the DMAs;

FIG. 21 illustrates an example of contents in the PDL; and

FIG. 22 illustrates an example of contents in the SDL.

### DETAILED DESCRIPTION

One embodiment of the present invention will be described in more detail with reference to the accompanying drawings.

An information record/playback apparatus according to one embodiment of the present invention is provided for executing a replacing operation based on the defect management information on a recording medium (optical disk). More specifically, the apparatus is for selecting the latest location information from a plurality of location information (referred to as DMA managers hereinafter) which indicate a plurality of locations of defect management areas (referred to as DMAs hereinafter) and for selecting a DMA corresponding to the location information which the latest location information shows. Although the latest DMA manager is not always available, its processing technique will be explained below in more detail.

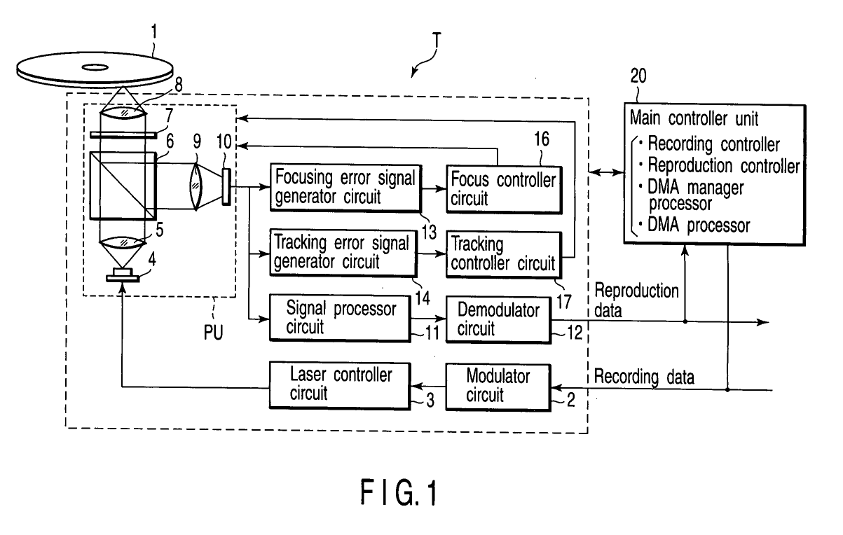

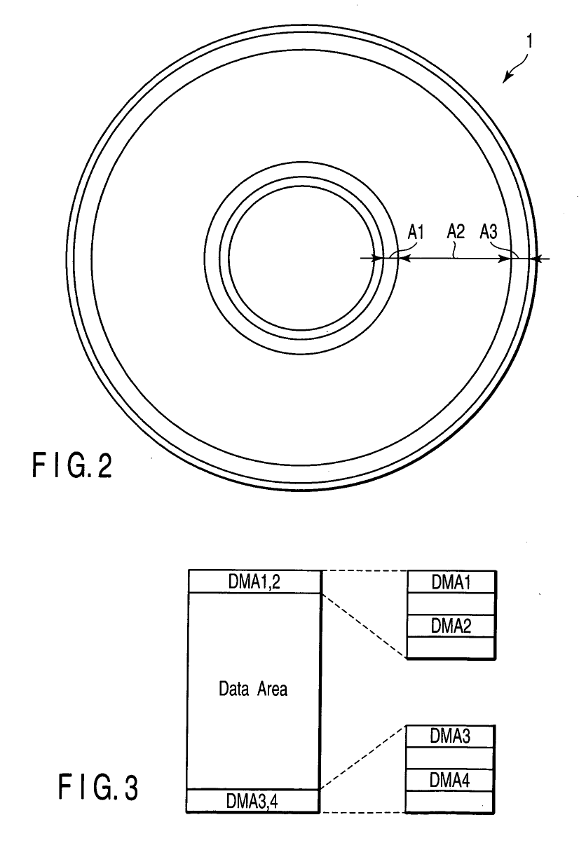

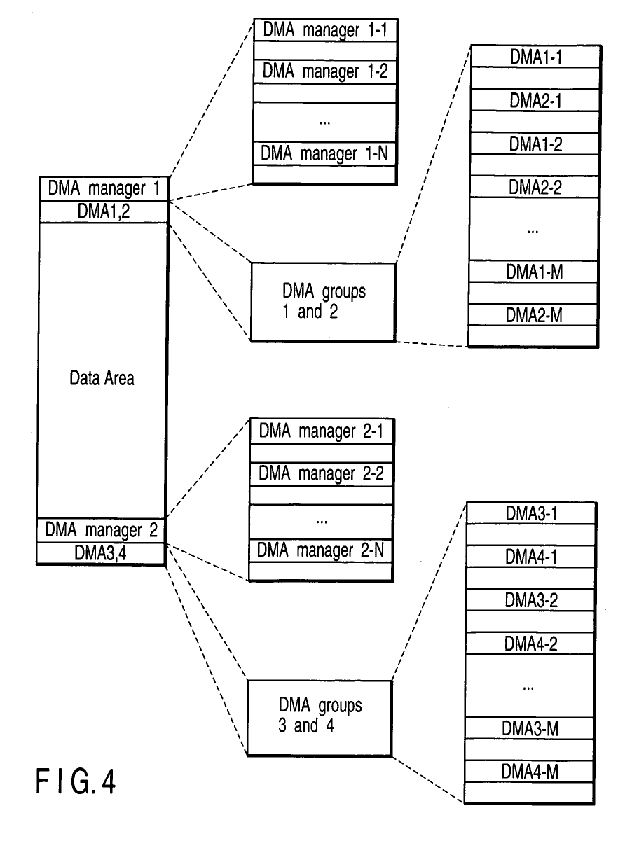

FIG. 1 is a diagram showing an example of a schematic configuration of the information playback apparatus according to one embodiment of the invention. FIG. 2 is an external view showing one example of a recording medium to be handled by the information playback apparatus of one embodiment of the invention. FIG. 3 is an explanatory diagram showing an allocation of DMAs on a DVD-RAM disk to be handled by the information playback apparatus of one embodiment of the invention. FIG. 4 is an explanatory diagram showing another allocation of DAMs on a DVD-RAM disk to be handled by the information playback apparatus of one embodiment of the invention.

(Example of Information Record/Playback Apparatus According to the Invention)

(Configuration)

One example of the configuration of the information record/playback apparatus according to one embodiment of the invention will be described in more detail with reference to the relevant drawings. FIG. 1 is a diagram showing a schematic configuration of the information record/playback apparatus according to the embodiment of the invention. The information record/playback apparatus T is configured to record user data to a recording media (optical disk) 1, and play back the user data stored in the recording medium (optical disk) 1. The information record/playback apparatus is also adapted for executing a replacing operation if desired.

The information record/playback apparatus T includes, as shown in FIG. 1, a modulator circuit 2, a laser controller circuit 3, and an optical pickup PU connected to the laser controller circuit 3. The optical pickup PU comprises a laser 4, a collimator lens 5, a polarizing beam splitter (PBS) 6, a quarter wavelength plate 7, an objective lens 8, a collector lens 9, and an optical detector 10. Further, the information record/playback apparatus T also includes a signal processor circuit 11, a demodulator circuit 12, a focusing error signal generator circuit 13, a tracking error signal generator circuit 14, a focusing controller circuit 16, a tracking controller circuit 17, and a main controller 20.

The main controller 20 is provided for controlling a drive unit to conduct control of recording processing, control of playback processing, DMA processing, and DMA manager processing as a part of the embodiment of the invention. The drive unit includes the modulator circuit 2, the laser controller circuit 3, the laser 4, the collimator lens 5, the polarizing beam splitter 6, the quarter wavelength plate 7, the objective lens 8, the collector lens 9, the optical detector 10, the signal processor circuit 11, the demodulator circuit 12, the focusing error signal generator circuit 13, the tracking error signal generator circuit 14, the focusing controller circuit 16, and the tracking controller circuit 17.

(Operation)

The operation of processing in the information record/playback apparatus T as the embodiment of the invention will be described. First, description will be given for recording of data in the information record/playback apparatus T. The operation of recording data is controlled by the main controller 20. The recording data (data symbol) is modulated into a series of predetermined channel bits by the demodulator circuit 2. A series of channel bits corresponding to the recording data are then converted into a laser driving waveform by the laser controller circuit 3. The laser controller circuit 3 pulse-drives the laser 4 and records data corresponding to desired bit series on the recording medium 1. A light beam for recording emitted from the laser 4 is turned to a parallel light by the collimator lens 5, and received and permeated by the PBS 6. The beam released from the PBS 6 is made to pass through the quarter wavelength plate 7 and focused by the objective lens 8 on an information recording surface of the medium 1. The focused beam is then maintained to produce a small spot of light on the recording surface by the focusing control operation of the focusing controller circuit 16 and the tracking control operation of the focusing controller circuit 17.

Then, the operation of playing back data in the information record/playback apparatus will be described. The operation of playing back data is also controlled by the main controller 20. In response to a data playback command from the main controller 20, the laser 4 emits a light beam for reproduction. The light beam for playback emitted from the laser 4 is turned by the collimator lens 5 to a parallel light and received and permeated by the PBS 6. The light beam permeated from the PBS 6 is made to pass through the quarter wavelength plate 7 and focused by the objective lens 8 onto the information recording surface of the medium 1. The focused light beam is then maintained to produce a small spot of light on the recording surface by the focusing control operation of the focusing controller circuit 16 and the tracking control operation of the focusing controller circuit 17. Then, the light beam for playback irradiated on the media 1 is reflected on a reflecting layer or reflective recording layer at the information recording surface. A reflection light is made to pass through the objective lens 8 and runs in a reverse direction as a parallel light. The reflection light is received by the quarter wavelength plate 7 where it is polarized in a vertical direction. The polarized light is thus reflected by the PBS 6, turned to a converged light by the collector lens 9, and received by the optical detector 10. The optical detector 10 may be a four-divided photo-detector. The converged light is photo-electrically converted into an electric signal in the optical detector 10. The electric signal is then amplified and received by the signal processor circuit 11 where it is binarized before transferred to the demodulator circuit 12. The binarized signal is demodulated corresponding to the predetermined demodulation method to playback data by a demodulating operation of the demodulator circuit 12.

Meanwhile, the electric signal outputted from the optical detector 10 is transferred to the focusing error signal generator circuit 13 where it is examined to generate a focusing error signal. Similarly, the electric signal outputted from the optical detector 10 is transferred to the tracking error signal generator circuit 14 where it is examined to generate a tracking error signal. The focusing controller circuit 16 controls the focusing operation at the spot of light on the basis of the focusing error signal. The tracking controller circuit 17 controls the tracking operation of the spot of light on the basis of the tracking error signal.

The operation of replacement process of the main controller 20 for DMA processing will be described. A certifying operation is conducted for formatting the medium. During the operation, the main controller 20 detects any defect on the medium. Upon being found, defect information or defect management information about an initial defect is recorded in a PDL in the DMA of the medium by the main controller 20. The defect management information includes an address of a replacing sector and an address of a sector to be replaced. In a common recording operation, the main controller 20 detects any defect on the medium. Any defect or defect management information about a secondary defect is stored in an SDL in the DMA of the medium by the main controller 20. The defect management information includes an address of the leading sector in a replacing ECC block and an address of the leading sector in an ECC block to be replaced. Based on the PDL and SDL, the operation of accessing the replacing sector is considered as the operation of accessing the sector to be replaced.

The main controller 20 also conducts a DMA manager processing operation for specifying the latest DMA from a plurality of the DMA for replacing the DMA. The DMA manager processing operation will now be explained referring to the relevant flowcharts.

(DMA Manager Processing Operation of Information Record/Playback Apparatus According to the Present Invention)

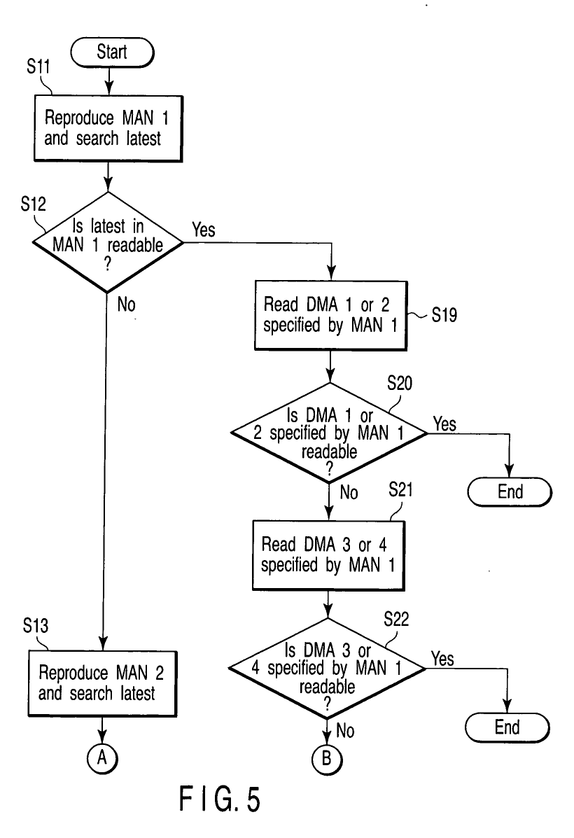

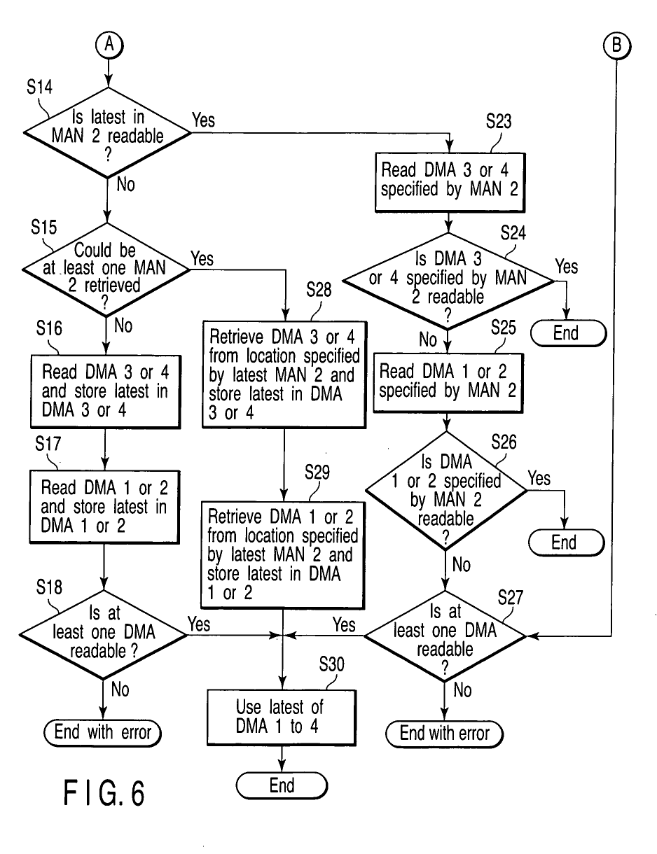

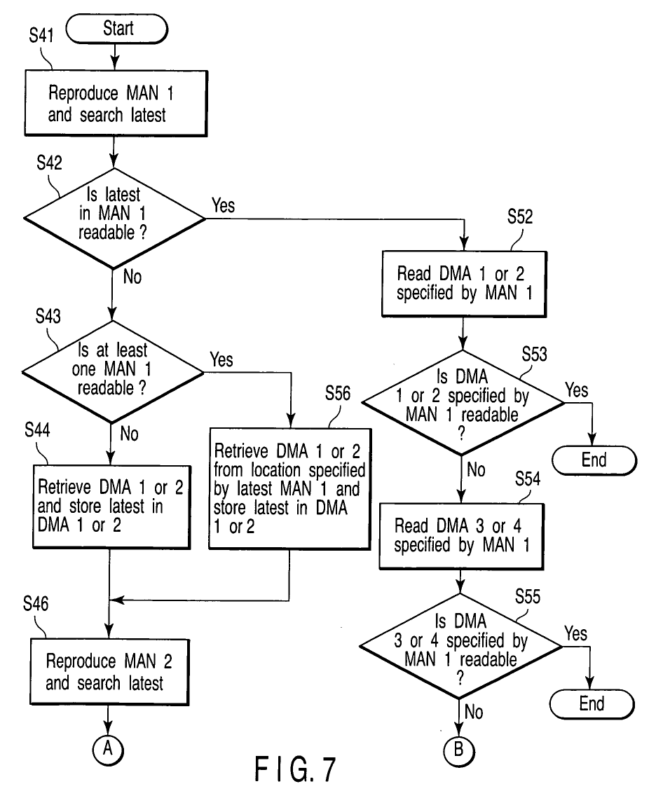

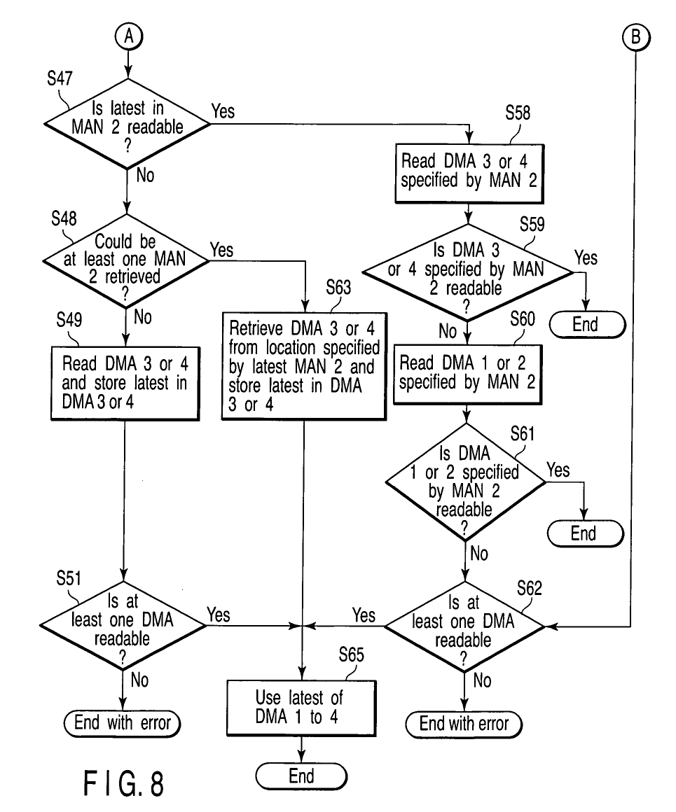

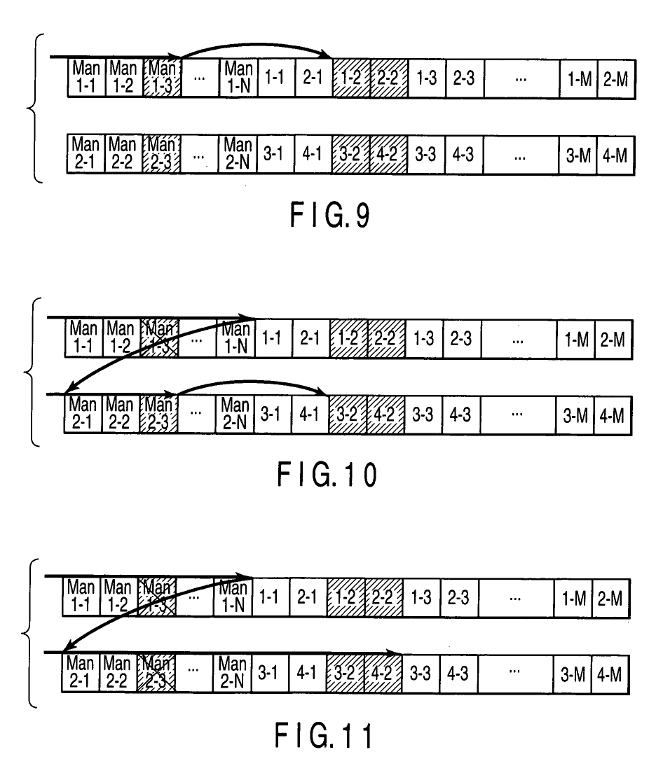

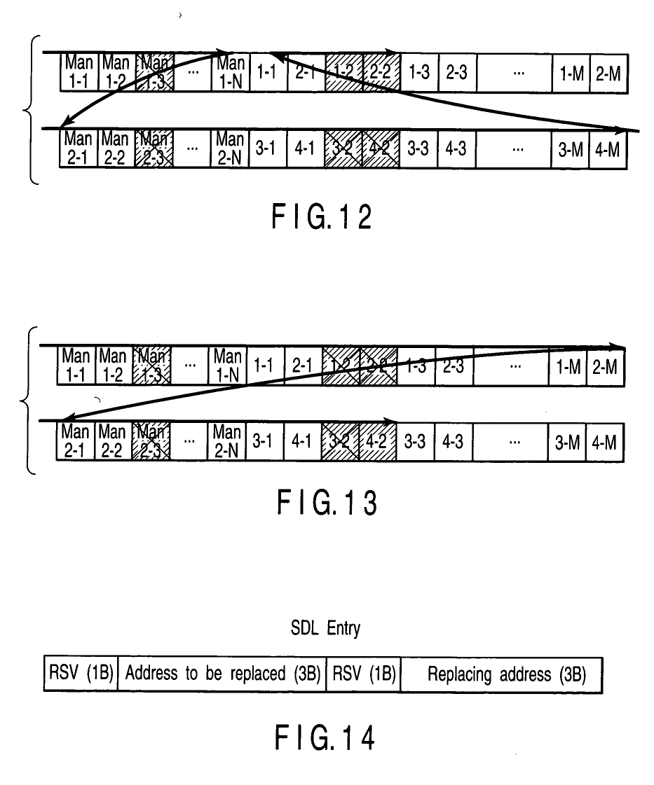

The DMA manager processing will be described with reference to the following flowchart. FIG. 5 is a flowchart showing an example of the DMA manager processing operation executed by the information record/playback apparatus of one embodiment of the invention. FIG. 6 is a flowchart showing an example of the DMA manager processing operation executed by the information record/playback apparatus of one embodiment of the invention. FIG. 7 is a flowchart showing another example of the DMA manager processing operation executed by the information record/playback apparatus of one embodiment of the invention. FIG. 8 is a flowchart showing another example of the DMA manager processing operation executed by the information record/playback apparatus of one embodiment of the invention. FIG. 9 is an explanatory diagram showing a sequence of the playback operation executed by the information record/playback apparatus of one embodiment of the invention. FIG. 10 is an explanatory diagram showing the sequence of the playback operation executed by the information record/playback apparatus of one embodiment of the invention. FIG. 11 is an explanatory diagram showing the sequence of the playback operation executed by the information record/playback apparatus of one embodiment of the invention. FIG. 12 is an explanatory diagram showing the sequence of the playback operation executed by the information record/playback apparatus of one embodiment of the invention. FIG. 13 is an explanatory diagram showing the sequence of the playback operation executed by the information record/playback apparatus of one embodiment of the invention.

(DMA Manager and DMA on Recording Medium)

An example of the recording medium 1 to be handled by the information record/playback apparatus T of one embodiment of the invention has a read-in area A1 arranged at the innermost and a read-out area A3 arranged at the outermost, as shown in FIG. 2. The recording medium 1 also has an information area A2 arranged between the read-in area A1 and the read-out area A3. The information area A2 has a user area UA and a spare area SA.

The read-in area A1 at the innermost comprises, as shown in FIG. 3, a first series of DMA (DMA series 1 and 2) while the read-out area A3 at the outermost comprises a second series of DMA (DMA series 3 and 4). More specifically, the read-in area A1 comprises a group of DMA managers 1-1 to 1-N, a group of DMAs 1-1 to 1-M, and another group of DMAs 2-1 to 2-M while the read-out area A3 comprises a group of DMA managers 2-1 to 2-N, a group of DMAs 3-1 to 3-M, and another group of DMAs 4-1 to 4-M, as shown in FIG. 4.

The DMAs are physically separated into two series: one of the two series at the innermost and the other at the outermost of the medium. As the result, the DMAs are less susceptible to troubles.

(DMA Manager Processing Method)

The information record/playback apparatus T of the present invention first determines the latest DMA for processing (replacing processing) the DMA. The operation starts with reading out all the DMA managers, detecting the latest DMA manager, and specifying the latest DMA corresponding to location instructed by the latest DMA manager. It is however true that all the DMA managers are not always read out and the latest DMA manager are not always specified. Accordingly, when the latest DMA manager fails to be readily detected, another appropriate DMA manager may be specified by performing following operation.

The choosing operation starts with the information record/playback apparatus T searching available DMA managers before accessing the latest DMA from the information of the available DMA managers. The DMA to be accessed may be not one but two or more. Then, the first of the readable DMAs is determined as the latest. If no DMA managers are reproduced, the DMA are accessed in a sequence and their latest is employed. Techniques of a first and a second of the DMA manager processing operation will now be explained.

The first technique is provided for shifting immediately to the read-out side when the operation for specifying the DMA manager on read-in side is failed. The second technique is provided for reading the DMA from the read-in side and then shifting to the read-out side when the operation of specifying the DMA manager is failed. Their procedures will now be explained in more detail.

(First Technique)

The DMA manager procedure in the flowcharts of FIGS. 5 and 6 starts with reproducing MAN 1 sequentially and searching the latest among the MAN 1 (S11). The method of specifying the latest among a plurality of DMA managers 1-1 to 1-N is not limited to a particular one. For example, there is a technique that the latest may be determined from the greatest of an address value which represents the location of the latest manager. Alternatively, as a counter, not shown, is provided in the DMA manager area, its greatest value may indicate the latest DMA manager. Moreover, while the latest DMA manager is assigned with an identifier, it can be specified by detecting its identifier. The method is not limited to those described methods.

When all the DMA managers 1-1 to 1-N have been read out and the latest MAN 1 is successfully specified (S12), DMA 1 or DMA 2 specified by the latest MAN 1 are retrieved (S19). As DMA 1 or DMA 2 specified by the MAN 1 has been read out, the procedure is closed. When the retrieval fails (S20), DMA 3 or DMA 4 specified by the MAN 1 is read out before the procedure is closed (S21).

This will now be explained referring to FIG. 9. The latest DMA managers are MAN 1-3 and MAN 2-3 and their DMA comprise DMA 1-2 and DMA 2-2, and DMA 3-2 and DMA 4-2 are the latest DMA, and the DMA managers are retrieved and played back in a sequence starting from MAN 1-1. The latest is then found at MAN 1-3 and successfully read in. Then, the DMAs are read out from 1-2. When all the DMAs have been read out, the procedure is closed.

However, if all the DMAs specified by the manager MAN 1 fail to be retrieved (S22), the procedure jumps to step S27.

When it is determined in step S12 that the latest is not retrieved because any injury or dirt on the disk interrupts to read the manager MAN 1, the DMA managers 2 at the read-out side are reproduced to search the latest (S13).

This procedure will now be explained referring to FIG. 10. When MAN 1-3 which may be the latest is not retrieved, it is hardly determined whether MAN 1-3 as the latest fails to be read or MAN 1-2 is the latest. In the flowcharts shown in FIGS. 5 and 6, MAN 2 is determined retrievable and its retrieval starts without examining DMA 1 or DMA 2. The duration of time required for scanning can be reduced when MAN 2 is successfully retrieved. As shown in FIG. 10, the latest MAN 2-3 is retrieved and then DMA 3-2 specified by the latest MAN 2-3 is shown.

When all the MAN 2 has been retrieved and the latest is specified among the MAN 2 (S14), DMA 3 or DMA 4 specified by the latest MAN 2 is read out (S23). As DMA 3 or DMA 4 has been read out, the procedure is closed. If not (S24), DMA 1 or DMA 2 specified by the latest DMA manger 2 is retrieved (S25). When DMA 1 or DMA 2 specified by the DMA manger 2 has been retrieved (S26), the procedure is closed. If not, it is determined again whether or not at least one DMA has been read out (S27). If not, the procedure is closed with an error signal.

When the latest DMA manager 2 is not specified (S14), it is then determined whether at least one manager in MAN 2 is retrieved or not (S15). When it is determined that at least one manager is retrieved, DMA 3 or DMA 4 is read out from a location at the latest in read MAN 2 and its latest of the DMA 3 or 4 is stored (S28). Similarly, DMA 1 or DMA 2 is read out from a location at the latest in read MAN 2 and its latest value of the DMA 1 or 2 is stored (S29). Then, the latest is specified from DAM areas 1 to 4 and used as the defect management information for replacement (S30).

When it is determined in step S15 that the DMA managers 2 are not retrieved, DMA 3 or DMA 4 is read out from the leading end and its latest is stored (S16).

FIG. 11 illustrates this step when neither MAN 1 nor MAN 2 is retrieved. As the procedure continues, the latest can be found at DMA 4-2. Then, the procedure is closed.

As the latest has not been found, DMA 1 or DMA 2 is retrieved from the leading end and its latest is stored (S17). FIG. 12 illustrates this step where neither MAN 1 nor MAN 2 is retrieved and also the DMA 3-2 or DMA 4-2 which may be the latest in DMA 3 or DMA 4 are not retrieved. It is hardly determined whether the latest of DMA 3 or DMA 4 is not retrieved or DMA 3-1 or DMA 4-1 is the latest. Hence, DMA 1 or DMA 2 has to be determined before determining the latest. Since MAN 1 and MAN 2 fail to be retrieved, a case that the retrieving operation starts scanning one by one from DMA 1-1 is shown (cf. When MAN 2-2 is successfully retrieved, the retrieving operation may start from DMA specified by MAN 2-2 without scanning from the leading end).

When no DMA is retrieved, the procedure is closed with an error signal (S18). When at least one DMA is retrieved, the latest read from the DMA 1 to 4 is used as the defect management information for replacement (S30).

Using the foregoing technique for carrying out a preliminarily prepared sequence of steps, an appropriate DMA can be determined even if the DMA managers fail to be read out completely or the latest of the DMA managers is hardly specified due to any injury or dirt on the disk. Accordingly, when any readout error occurs, the appropriate DMA can be used for executing a playback operation at a permissive level.

The above description is described shifting from the innermost (MAN 1 and DMAs 1 and 2) to the outermost (MAN 2 and DMAs 3 and 4). A reverse of the shift will be made with equal success from the outermost to the innermost of the disk.

(Second Technique)

The second technique is useful when employs an algorithm for, when a particular manager is not retrieved, its neighbor DMA (DMA 1 or 2 in MAN 1) is examined to determine the latest. Therefore, this is effectively used when the reliability of each manager is presumably low or the number of access operations between the innermost and the outermost of the disk is desired to be minimized.

FIG. 13 illustrates steps of the second procedure where the retrieving operation starts from the DMA area specified by the preceding retrieved manager or from the leading end at DMA 1 or DMA 2 when MAN 1-3 is not retrieved. When the latest is not found, the operation is shifted to the outermost of the disk for retrieving MAN 2 and repeated at the same steps.

As shown in the flowcharts of FIGS. 7 and 8, the DMA manger reproduces a series of the MAN 1 and searches the latest among thereof (S41). When all the DMA managers 1-1 to 1-N have been read out and their latest of the MAN 1 are found (S42), DMA 1 or DMA 2 specified by MAN 1 is retrieved (S52). When DMA 1 or DMA 2 specified by MAN 1 has successfully been retrieved, the procedure is closed. If DMA 1 or DMA 2 specified by MAN 1 is retrieved (S53), DMA 3 or DMA 4 specified by MAN 1 is retrieved. When the retrieval is completed, the procedure is closed (S54). When DMA 3 or DMA 4 specified by MAN 1 has not been retrieved (S55), the procedure transfers to step S27.

When step S42 determines that all the managers in MAN 1 are not retrieved and their latest is not specified, it is determined again whether or not at least one MAN 1 is retrieved (S43). When so, DMA 1 or DMA 2 is read out from a location at the latest in MAN 1 and its latest is stored (S56).

When it is determined in step S43 that no MAN 1 is retrieved, DMA 1 or DMA 2 are read out from the leading end and its latest is stored (S44).

It is further examined in step S46 whether the DMA managers 2 at the lead-out side are reproduced in a sequence and their latest is searched (S46). When all MAN 2 have been retrieved and their latest is specified (S47), DMA 3 or 4 specified by MAN 2 is read out (S58). As DMA 3 or DMA 4 has been retrieved, the procedure is closed. If not (S59), DMA 1 or DMA 2 specified by the DMA manager 2 is retrieved (S60). As DMA 1 or DMA 2 specified by the DMA manager 2 has been retrieved (S61), the procedure is closed. If not, it is determined whether or not at least one DMA area is retrieved (S62). When no DMA area is retrieved, the procedure is closed with an error signal.

When it is determined in step S47 that the latest of the DMA managers 2 is not specified, it is then determined whether or not at least one MAN 2 is retrieved (S48). When at least a part of MAN 2 is retrieved, DMA 3 or DMA 4 is read out from a location at the latest in MAN 2 in a range of the read MAN 2 and its latest value is stored (S63). Then, the latest is specified among the retrieved value of DMA 1 to 4 and used as the defect management information for replacement (S65).

When it is determined in step S48 that no DMA manager 2 is retrieved, DMA 3 or DMA 4 is read out from the leading end with no use of the DMA managers and its latest is stored (S49). When no DMA is retrieved, the procedure is closed with an error signal (S51). When at least one DMA is retrieved, its latest among the retrieved DMA is read out and used as the defect management information for replacement (S65).

Using the foregoing technique for carrying out a preliminarily prepared sequence of steps, the appropriate DMA can be determined even if the DMA managers fail to be read out completely or the latest of the DMA managers is hardly specified due to any injury or dirt on the disk. Accordingly, when any readout error occurs, the applicable DMA can be read out and used for executing a playback operation at a permissive level.

The first technique is consequently faster in the processing speed than the second technique when the DMA managers 2 are readable. The second technique is faster in the processing speed than the first technique when all the DMAs are read out with no manager being retrieved and their latest is specified. Accordingly, the DMA processing operation can favorably be selected between the two procedures depending on the state of retrieving operations on a disk, thus minimizing the consumption of time.

As set forth above, any non-recordable DMA area can be replaced by the most available one of the spared DMAs assigned to the defect management operation, whereby the number of recording operations can be increased before the re-writing is no more allowed. More specifically, the number of recording operations can be increased to a level equal to the number of the spare DMAs. For example, when a disk assigned with 1000 times of the over-writing carries ten DMAs, its over writing operation will be repeated 10 times greater totaling 10000 times.

Also, since the location of the latest DMA is written in a DMA manager, the latest DMA for replacement will need no initial scanning, allowing the extra access time required for replacement of the DMA to be minimized.

The information record/playback apparatus of one embodiment can carry out the foregoing DMA manager processing steps to find the latest DMA within a short period of time, hence ensuring that the succeeding operation of replacement is conducted with higher stability and reliability.

(Information Recording Medium for Use in Information Record/Playback Apparatus)

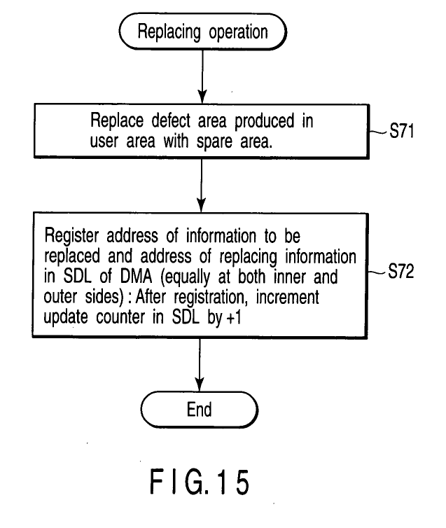

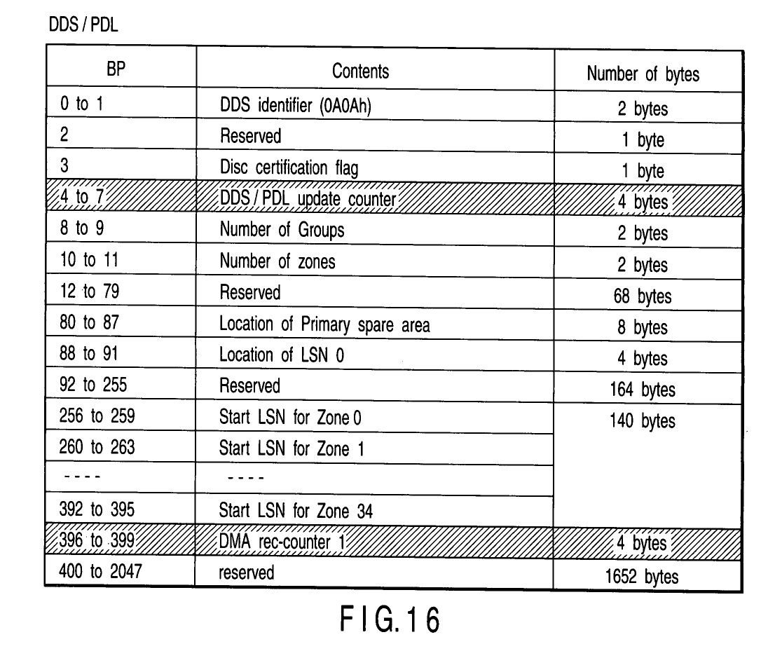

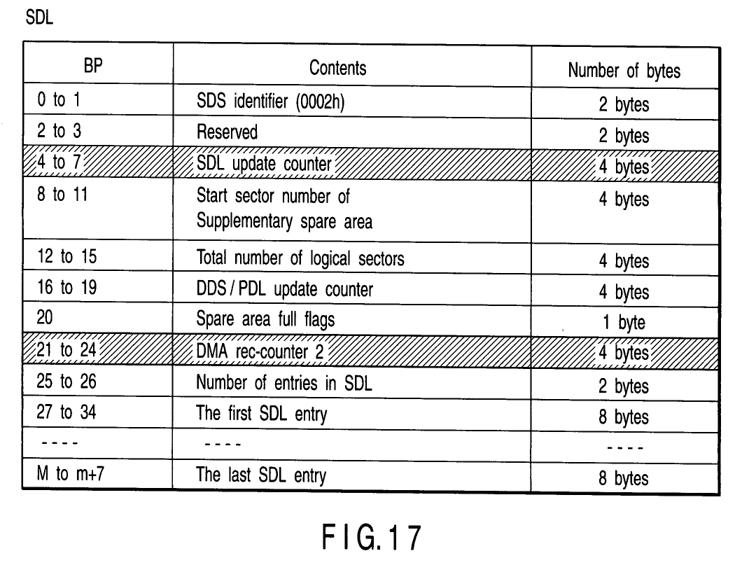

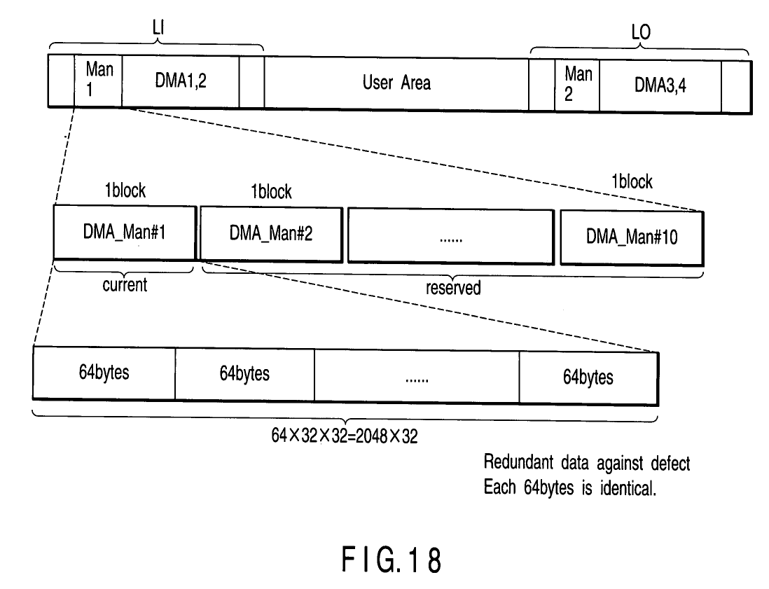

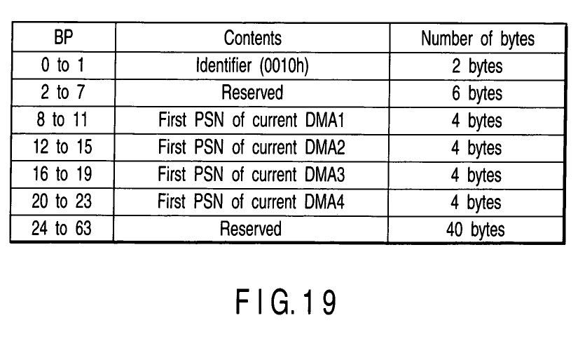

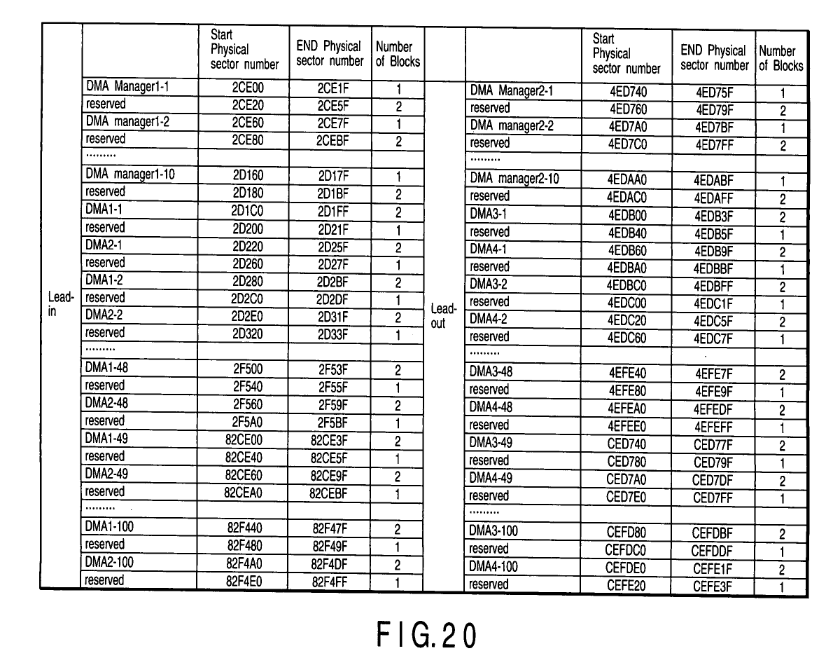

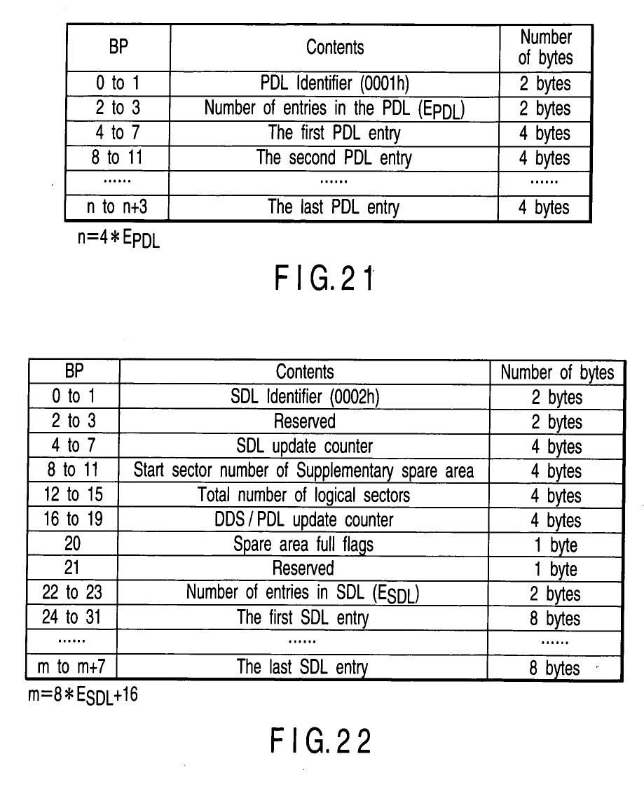

A information recording medium on which the DAM manager process and the DMA process of the information record/playback apparatus are carried out will now be described referring to the relevant drawings. While the information recording medium described is illustrative but of no limitations, the DMA manager process and the DMA process of the embodiment can be applied with equal success to any other form of the information recording medium. FIG. 14 is an explanatory diagram showing an assignment of address areas for the replacing operation executed by the information record/playback apparatus of the embodiment. FIG. 15 is a flowchart showing steps of the replacing operation. FIG. 16 illustrates an allocation of contents in the leading sector of a DDS/PDL block in the DMA area of a disk to be played back by the information record/playback apparatus of the embodiment. FIG. 17 illustrates an allocation of contents in the SDL block in the DMA area of the disk. FIG. 18 illustrates an allocation of the DMAs, the DMA manager areas, and the information stored in each DMA manager area. FIG. 19 illustrates an assignment of the DMA manager information in a spare DMA manager area. FIG. 20 illustrates an allocation of the DMA manager areas and the DMAs. FIG. 21 illustrates an allocation of contents in the SDL block.

(Replacing Operation)

An example of the replacing operation will first be described. FIG. 14 is an explanatory diagram showing an assignment of the address areas. FIG. 15 is a flowchart showing the replacing operation. As shown in FIGS. 14 and 15, data to be recorded in a defect data generated in a user area is stored in the spare area SA for replacement (S71). The address of an area to be replaced (a defect area) and the address of a replacing area (a spare area in SA) are registered in the SDL (secondary defect list) in the DAM area. The DMAs may be disposed on the innermost and outermost of the recording medium or disk, as shown in FIG. 1, where the same information is registered respectively. When the SDL is filled with information, the update counter of the SDL is incremented (by +1) (S72).

FIG. 16 illustrates an allocation of contents in the leading sector of a DDS/PDL block in the DMA area. A predetermined area of the DDS/PDL block contains a DDS/PDL update counter of 4 bytes and a DMA rec-counter 1 of 4 bytes.

Whenever the content of the DDS/PDL block is updated, its DDS/PDL update counter is incremented (by +1). The DMA rec-counter 1 is provided for counting up when the DDS/PDL block is re-written. At the initial stage of the medium (for the first operation), each DMA rec-counter 1 is set with zero.

FIG. 17 illustrates an allocation of contents in the SDL block in the DMA area. A predetermined area of the SDL block contains an SDL update counter of 4 bytes, a DMA rec-counter 2 of 4 bytes, and a number of SDL entries.

When the contents of the SDL block similar to the DDS/PDL block is updated, its SDL update counter is incremented (by +1). The DMA rec-counter 2 is provided for counting up when the SDL block is re-written. The SDL block carries management information for secondary defects. At the initial stage of the medium (for the first operation), each DMA rec-counter 2 is set with zero.

(DMA Manager)

As shown in FIG. 18, the DMA manager areas (MAN 1 and MAN 2) are allocated to the read-in area and the read-out area of the medium. Both the DMA manager area (MAN 1) allocated to the read-in area and the DMA manager area (MAN 2) allocated to the read-out area carry the same information.

Every the DMA manager areas (MAN 1 and MAN 2) comprises a group of spare manager areas. This arrangement is made for DMA manager defects. As shown in FIG. 17, the DMA manager area (MAN 1) comprises ten spare manager areas (DMA_Man #1 to DMA_Man #10). Equally, the other DMA manager area (MAN 2) comprises ten spare manager areas (DMA_Man #1 to DMA_Man #10).

At the initial stage, the first spare manager area (DMA_Man #1) of each of the two DMA managers (MAN 1 and MAN 2) holds a information about the location of the spare DMA area in current use. When the first spare manager area (DMA_Man #1) of the DMA manager (MAN 1) is turned to a defect area through over-writing, the information stored in the first spare manager areas (DMA_Man #1) of both the DMA managers (MAN 1 and MAN 2) are transferred (re-written) to the second spare manager areas (DMA_Man #2) of the DMA managers (MAN 1 and MAN 2) respectively.

The DMA manager area is lower in the re-writing frequency than the DMA area. Accordingly, the generation of defects by over-writing will be less feasible at the spare DMA manager areas than at the DMAs. However, any physical injury or finger print on the medium may interrupt the retrieval of a desired DMA manager from the spare areas. For compensation, each DMA manager carries a plurality of identical data (about the location of current DAM). More specifically, the information about the current DMA location is repeated plural times in a single spare DMA manager area. This allows the data (about the location of current DAM) to be readily read out even if its ECC block has too many errors to be corrected.

Each DMA manager is stored in a spare manager area. The spare manager area incorporates a single ECC block. The information is then repeated at equal intervals of 64 bytes in the ECC block of one spare manager area. More particularly, the ECC block includes a row of 64-byte information about the location of the current DMA in use. For example, one ECC block consists of 32 sectors. One sector carries 2048 bytes. Hence, the size of one ECC block is equal to 2048 bytes×32 sectors. This allows the information to be repeated 32 times in each sector. The ECC block thus carries 32×32 times the information. Even if the ECC block contains too many errors to be corrected, its partial modification can allow the information (about the location of the current DMA in use) to be read out at a fair degree of the probability.

FIG. 19 illustrates an example of the DMA manager. As shown in FIG. 19, the DMA manager contains the address of four spare DMAs in use. For example, the four spare DMAs are DMA set #1-1, DMA set #2-1, DMA set #3-1, and DMA set #4-1. When the location of the spare DMAs in use is identified uniformly, the area number but not the address may be written and stored.

FIG. 20 illustrates a detailed assignment of the DMA managers and the DMAs. The DMA managers are stored in the spare DMA manager areas (DMA Manager 1-1 to DMA Manager 1-10) at the read-in area and the spare DMA manager areas (DMA Manager 2-1 to DMA Manager 2-10) at the read-out area. Also, the read-in area carries two DMAs (DMA 1 and DMA 2) while the read-out area carries two DMAs (DMA 3 and DMA 4).

FIG. 21 illustrates an allocation of contents in the PDL. The PDL carries a maximum of 15871 entries ((2048×31−4)/4=15871). FIG. 22 illustrates an assignment of contents in the SDL. The SDL carries a maximum of 8189 entries ((2048×31−24)/8=8189).

The information record/playback apparatus of the embodiment is designed for executing the DMA manager processing operation and the DMA processing operation on, but not limited to, a recording medium arranged by the foregoing manner. The apparatus may equally be operated with any other form of the recording medium at a higher speed and a degree of the reliability.

It would also be understood that the present invention is described in the form of the embodiments and other changes and modifications may be made by those who skilled in the art without departing from the scope of the present invention. The present invention may also be feasible in a variety of applications without inventive capabilities. The present invention will cover a wide range of entities which reside in the principles and novel features of the present invention while not limited to the above described embodiments.

What is claimed is:

1. A disk apparatus comprising:
a reader unit which reads a disk having a re-writable storage area, a plurality of defect management areas, and a plurality of location information areas that indicate the location of optimum one to be played back in the plurality of defect management areas, and which outputs a readout signal;
a playback unit which plays back information stored in the rewritable storage area in response to the readout signal of the reader unit on the basis of given defect management information; and
a controller unit which, when all the plurality of location information stored in the location information areas are accessed and some of them but not all are read out successfully, selects the latest location information among the plurality of location information read out successfully and controls the playback unit to execute a playback operation on the basis of one item of the defect management information specified by the selected latest location information.

2. A disk apparatus according to claim 1, wherein
the controller unit reads the plurality of location information at the read-in side of the disk and reads defect management information specified by the location information, and when failing to read the plurality of location information at the read-in side of the disk, the controller unit reads the plurality of location information at the read-out side and reads defect management information specified by the location information.

3. A disk apparatus according to claim 1, wherein
the controller unit reads the plurality of location information at the read-in side of the disk and reads defect management information specified by the location information; when failing to read the plurality of location information at the read-in side, reads the plurality of location information at the read-out side and reads defect management information specified by the location information; when reading some but not all of the plurality of location information at the read-out side, reads defect management information specified by the latest of the location information which have been successfully read out; and when reading none of the plurality of location information at the read-out side, reads all the defect management information at the read-in side as well as all the defect management information at the read-out side, selects the latest of the readout defect management information, and controls the playback unit to execute a playback operation on the basis of the selected latest defect management information.

4. A disk apparatus according to claim 1, wherein
the controller unit reads the plurality of location information at the read-in side of the disk and reads defect management information specified by the location information; when failing to read the plurality of location information at the read-in side, reads the defect management information at the read-in side and stores the latest of the defect management information, and then reads the plurality of location information at the read-out side and reads defect management information specified by the location information; and when failing to read the location information at the read-out side, reads the defect management information at the read-out side and stores the latest of the defect management information, and controls the playback unit to execute a playback operation on the basis of the specified defect management information or the latest of the stored defect management information.

5. A disk apparatus according to claim 1, wherein
the controller unit reads the plurality of location information at the read-in side of the disk and reads defect management information specified by the location information; when reading some but not all of the plurality of location information at the read-in side, reads defect management information specified by the latest of the location information which have been read out successfully and stores the latest defect management information, and also reads the plurality of location information at the read-out side and picks up defect management information specified by the location information; when reading some but not all of the plurality of location information at the read-out side, reads defect management information at the read-out side specified by the latest of the location information which have been read out successfully and stores the latest defect management information; and when reading none of the plurality of location information at the read-out side, reads the readout defect management information at the read-out side and stores the latest of the defect management information, and controls the playback unit to execute a playback operation on the basis of the specified defect management information or the latest of the stored defect management information.

6. A disk reproducing method comprising:
reading a disk having a re-writable storage area, a plurality of defect management areas, and a plurality of location information areas that indicate the location of optimum one to be reproduced in the defect management areas, and outputting a readout signal;
reading the plurality of location information stored in the location information areas in response to the readout signal, and when reading some but not all of the plurality of location information, selecting the latest location information among the plurality of location information which have been read out successfully, and determining one item of the defect management information specified by the latest location information; and
playing back information of the readout signal stored in the re-writable storage area on the basis of the determined one item of the defect management information.

7. A disk reproducing method according to claim 6, further comprising:
reading the plurality of location information at the read-in side of the disk to read defect management information specified by the location information, and when failing to read the plurality of location information at the read-in side, reading the plurality of location information at the read-out side to read defect management information specified by the location information, and executing a playback operation on the basis of the specified defect management information.

8. A disk reproducing method according to claim 6, further comprising:
reading the plurality of location information at the read-in side of the disk to read defect management information specified by the location information; when failing to read the plurality of location information at the read-in side, reading the location information at the read-out side to read defect management information specified by the location information; when reading some but not all of the plurality of location information at the read-out side, reading defect management information specified by the latest of the location information which have been successfully read out; and when reading none of the plurality of location information at the read-out side, reading all the defect management information at the read-in side as well as all the defect management information at the read-out side, selecting the latest of the readout defect management information, and executing a playback operation on the basis of the latest defect management information.

9. A disk reproducing method according to claim 6, further comprising:
reading the plurality of location information at the read-in side of the disk to read defect management information specified by the location information; when failing to read the plurality of location information at the read-in side, reading the defect management information at the read-in side and storing the latest of the defect management information, and then reading the plurality of location information at the read-out side to read defect management information specified by the location information; and when failing to read the plurality of location information at the read-out side, reading the defect management information at the read-out side and storing the latest of the defect management information, and executing a playback operation on the basis of the specified defect management information or the latest of the stored defect management information.

10. A disk reproducing method according to claim 6, further comprising:
reading the plurality of location information at the read-in side of the disk to read defect management information specified by the location information; when reading some but not all of the plurality of location information at the read-in side, reading defect management information specified by the latest of the location information which have been read out successfully and storing the latest defect management information, and also reading the plurality of location information at the read-out side to pick up defect management information specified by the location information; when reading some but not all of the plurality of location information at the read-out side, reading the defect management information at the read-out side specified by the latest of the location information which have been read out successfully and storing the latest defect management information; and when reading none of the plurality of location information at the read-out side, reading the defect management information at the read-out side and storing the latest of the defect management information, and executing a playback operation on the basis of the specified defect management information or the latest of the stored defect management information.
